(19) United States
(12) Patent Application Publication
(10) Pub. No.: US 2003/0036365 A1
(43) Pub. Date: Feb. 20, 2003

(54) Portable communications terminal with camera capable of taking pictures

(75) Inventor: Mituru Kuroda, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/208,979

(22) Filed: Aug. 1, 2002

(30) Foreign Application Priority Data
Aug. 16, 2001 (JP) 246936/2001

(51) Int. Cl. H04B 1/00

(52) U.S. Cl. 455/90; 455/66

(57) ABSTRACT

In one side of an upper casing of a portable communications terminal, a close-range-photography camera module, suitable for close-range photography, is provided. An open lens window is provided so that a lens portion of the close-range-photography camera module is exposed. In the opposite side of the upper casing, a long-range camera module having a greater magnifying power than the close-range-photography camera module is provided. An open lens window is provided so that a lens portion of the long-range camera module is exposed. Further, there is provided a flash unit for strong illumination when necessary.

### BACKGROUND OF THE INVENTION

1. Field of the Invention

The present invention relates to a portable communications terminal with a camera, such as a mobile phone, a portable handyphone system (PHS) or a portable information terminal equipped with a camera.

2. Description of the Related Art

As examples of a portable communications terminal with a camera in which the camera can be turned around, the following have been disclosed in the official gazettes below.

In Japanese Laid-Open Patent Application 2001-136254, as shown in FIG. 1, a first casing 70a comprises a display portion 71, a speaker 72 and an antenna 73. A second casing 70b, comprising an operation portion 74 and a microphone 75, are coupled by means of a hinge 76, whereby a portable communications terminal main unit 70 is made freely foldable. A third casing 70c comprises a camera 77 is coupled to the second casing 70b by means of two universal couplings 78a and 78b, whereby the camera 77 and the third casing 70c are made freely rotatable in 360 degrees. Alternatively, as shown in FIG. 2, only a camera portion 80 is made to be freely rotatable in 360 degrees with respect to the second casing 70b by a universal coupling 81. Alternatively, as shown in FIG. 3, only a camera portion 90 is made to be freely rotatable in 360 degrees with respect to the main casing 70a by a universal coupling 91.

In Japanese Laid-Open Patent Application 2000-253118, as shown in FIGS. 4A and 4B, a camera 102 is supported in a freely rotatable fashion by means of a shaft 103 on a camera mount 101. The camera mount 101 is a separate unit from a portable communications terminal main casing and serves as a camera unit 104. A knob 105 connected to the shaft 103 is used to rotate the camera 102 so as to turn around the camera. The camera 102 is freely attachable/detachable with respect to the camera mount 101 and with respect to the portable communications terminal main unit 100.

However, when the camera is freely rotatable (i.e., by means of the universal coupling or by the shaft), it is necessary to provide inside the universal coupling or the shaft a flexible printed circuit board or a coaxial cable or other such wiring for electrically connecting the camera and the circuitry inside the portable communications terminal. Thus, the necessary wiring becomes complicated. Further, due to compactness requirements that place limitations on the mounting, it is difficult to furnish a shaft mechanism that has sufficient mechanical strength. Thus, in a case where a user drops the portable communications terminal, a great impact load is borne by the camera and the shaft portion. The likely result is breakage of the camera and the shaft portion. Thus, there is a problem that it is difficult to ensure reliability of the device.

### SUMMARY OF THE INVENTION

An aspect of the present invention is to solve the above-mentioned problems and provide a portable communications terminal with a camera. The portable communications terminal is capable of capturing images on a front side and a rear side of the terminal without rotating the camera itself. The mechanism of the camera portion is constructed as to be highly stable with respect to impacts.

To solve the above-mentioned problem, a mobile portable communications terminal of the present invention comprises a first casing, and a second casing connected to the first casing. The mobile portable communications terminal further comprises a first taking means for capturing images disposed on the first casing, and second taking means capturing images disposed on the second casing. The optical characteristics of the first taking means and the second taking means differ from each other. The first taking means is for close-range photography and the second taking means is for long-range photography. The first taking means and the second taking means are physically arranged such that they are positioned back-to-back to each other. The portable communications terminal further comprises an illuminating means to allow photography in a dark place. The illuminating means is provided on at least one of the first casing and the second casing. The portable communications terminal can be a portable telephone.

Another mobile portable communications terminal of the present invention comprises a first casing and a second casing connected to the first casing. The mobile portable communications terminal further comprises a taking means for capturing images, a first photography window disposed in the first casing, and a second photography window disposed in the second casing. The mobile portable communications terminal further comprises a switching means for switching between an image from the first photography window and an image from the second photography window, and directing means for directing the image to the taking means. The switching means can be manually switched. The portable communications terminal may comprise a lens arranged to at least one of the first photography window and the second photography window. The portable communications terminal further comprises an illuminating means to allow photography in a dark place. The illuminating means is provided on at least one of the first casing and the second casing. The portable communications terminal can be a portable telephone.

Another mobile portable communications terminal of the present invention comprises a first casing and a second casing that connects with the first casing. The mobile portable communications terminal further comprises a first camera module disposed on the first casing, and a second camera module disposed on the second casing. The optical characteristics of the first camera module and the second camera module differ from each other. The first camera module is for close-range photography and the second camera module is for long-range photography. The first camera module and the second camera module are physically arranged such that they are positioned back-to-back with each other. The portable communications terminal of the present invention further comprises a flash unit that allows photography in a dark place. The flash is disposed on at least one of the first casing and the second casing. The portable communications terminal can be a portable telephone.

Another portable communications terminal of the present invention comprises a first casing, and a second casing connected to the first casing. The mobile portable communications terminal further comprises a camera module, a first photography window disposed in the first casing and a second photography window disposed in the second casing. The mobile portable communications terminal further comprises a switching circuit that switches between an image from the first photography window and an image from the second photography window, and a directing circuit for directing the image to the camera module. The switching circuit is manually switched. The portable communications terminal comprises a lens arranged to at least one of the first photography window and the second photography window. The portable communications terminal further comprises a flash unit that allows photography in a dark place. The flash unit is provided on at least one of the first casing and the second casing. The portable communications terminal can be a portable telephone.

Furthermore, a portable communications terminal with a camera comprises a first camera module oriented toward a front side thereof and a second camera module oriented toward a rear side thereof. Optical characteristics of the first camera module and the second camera module differ from each other. One of the first camera module and the second camera module is for close-range photography and the other is for long-range photography. The first camera module and the second camera module are built in a manner such that they are positioned back-to-back with each other.

Another portable communications terminal of the present invention comprises a camera module, photography windows that are disposed in the front surface and the rear surface of the portable communications terminal, respectively. The mobile portable communications terminal further comprises an optical-path-switching optical system, provided in the portable communications terminal, for switching between an image from the front-side photography window and an image from the rear-side photography window and directing the image to the camera module. The optical-path-switching optical system is a mirror unit that can be rotated manually. The portable communications terminal further comprises a lens arranged to at least one of the front-side photography window and the rear-side photography window. The portable communications terminal further comprises a flash unit.

In accordance with the present invention, the two camera modules having different optical characteristics are fixed/arranged inside the portable communications terminal so that the lens surfaces thereof face toward the front side and the rear side of the terminal, respectively. Accordingly, when photographing the user during the video telephone call, the close-range photography is performed using the front-side camera module. On the other hand, when photographing scenery for example, the long-range photography is performed using the rear-side camera module. Thus, it becomes possible to perform photography according to the scene where it is used.

Further, one camera module is fixed/arranged inside the portable communications terminal. The optical-path-switching optical system switches between the image from a front-side photography window and the image from a rear-side photography window, to direct the image to the single camera module. Therefore, an effect similar to the one described above can be obtained even with one camera module.

Furthermore, it is not necessary to provide complicated rotational mechanisms and wiring as in the conventional constructions in which the camera module itself is constantly rotated for use, and thus a more compact and reliable device can be obtained.

### BRIEF DESCRIPTION OF THE DRAWINGS

These and other aspects, features and advantages of the invention will become more fully apparent from the following detailed description taken in conjunction with accompanying drawings. In the drawings:

FIG. 1 is a perspective view of a first related example;

FIG. 2 is a perspective view of a second related example;

FIG. 3 is a perspective view of a third related example;

FIG. 4A is a perspective view of a part of another related example;

FIG. 4B is an enlarged perspective view of a camera unit of another related example;

FIG. 5 is a frontal perspective view of a first embodiment of the present invention;

FIG. 6 is a rear perspective view of the same;

FIG. 7 is a cross-sectional view along a line X-X of FIG. 2;

FIG. 8 is a cross-sectional view along a line Y-Y of the same;

FIG. 9A is a front-side perspective view of a part of an upper casing of a second embodiment of the present invention;

FIG. 9B is a back-side perspective view of a part of an upper casing of a second embodiment of the present invention;

FIG. 10A is cross-sectional views along a line Z-Z shown in FIG. 9A, and shows a state in which a mirror unit is facing a rear-side photography window; and

FIG. 10B is cross-sectional views along a line Z-Z shown in FIG. 9A, and shows a state in which the mirror unit is facing a front-side photography window.

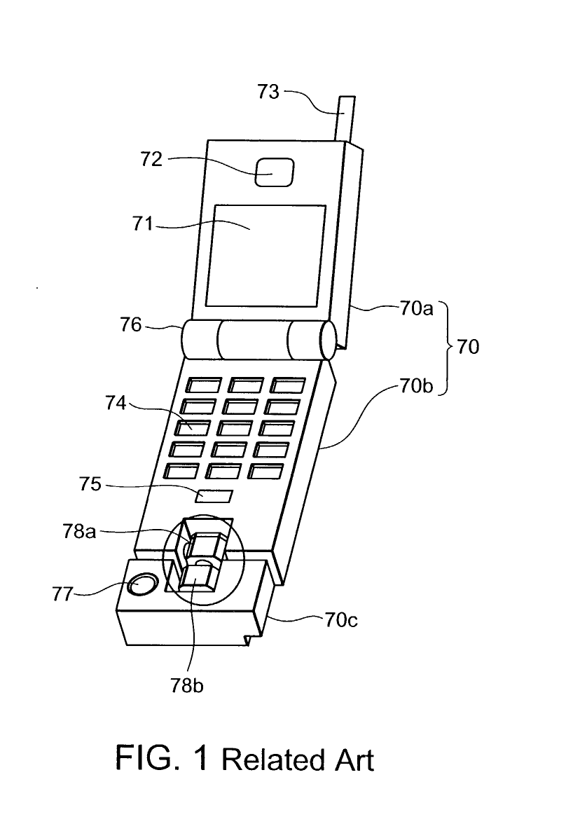

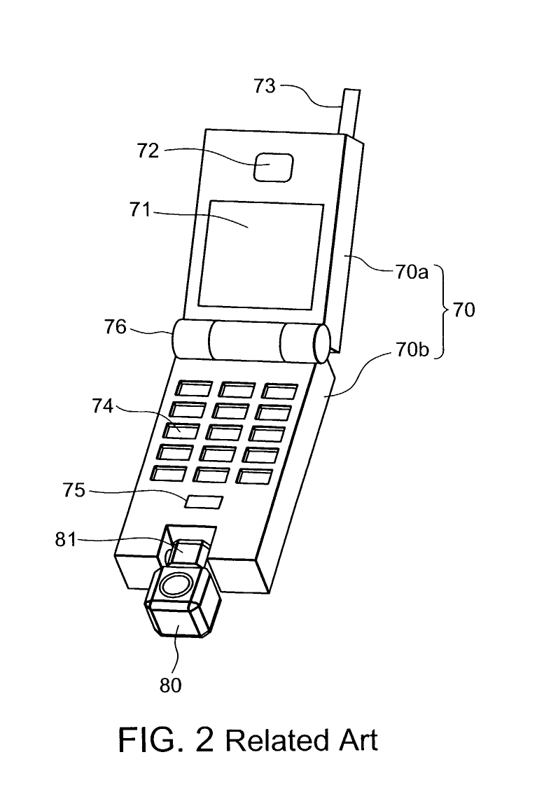

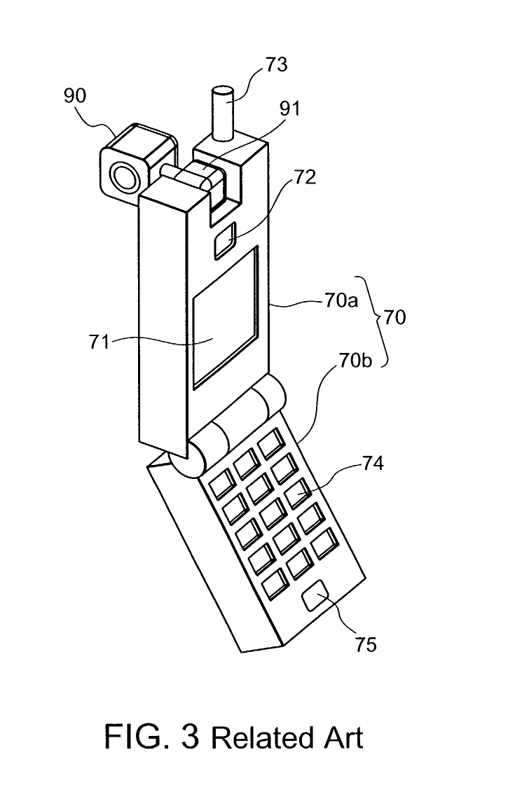

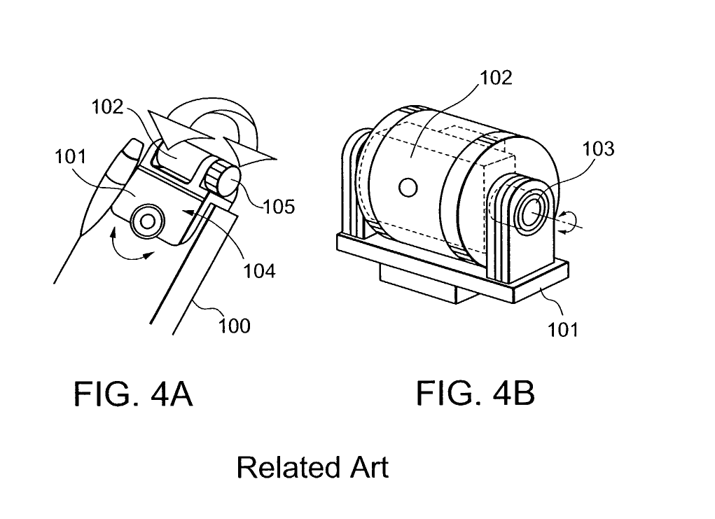

### DETAILED DESCRIPTION OF THE EMBODIMENTS

Hereinafter, each embodiment of the present invention will be described in detail with reference to the drawings.

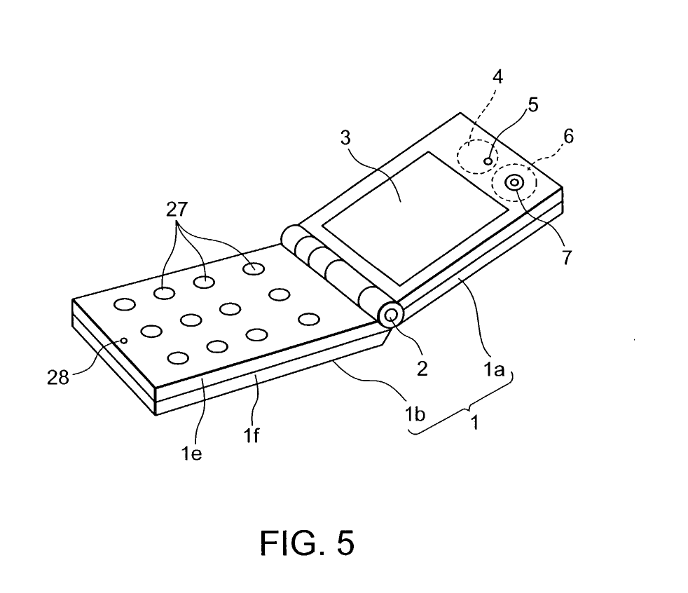

In the drawings, FIGS. 5-8 illustrate a first embodiment of the present invention in which the invention is applied in a folding mobile phone. A mobile phone main unit 1 has an upper casing 1a and a lower casing 1b coupled to each other by a hinge 2 so to be freely foldable.

As shown in FIG. 5 (front perspective view), at a central portion of the upper casing 1a, a display portion 3 is disposed, e.g., a LCD or similar device. Further, on an upper end portion of the upper casing 1a, there are provided a built-in receiver 4 which converts the voice of the other party into sound during a telephone conversation, and a sound passage hole 5 through which the sound is emitted. Further, adjacent to the receiver 4, a close-range-photography camera module 6 suitable for close-range photography is provided. The close-range-photography camera module 6 can have an adjustable focus range of approximately 30 cm to 1 m, and an open lens window 7 is provided so that a lens portion of the camera module 6 is exposed.

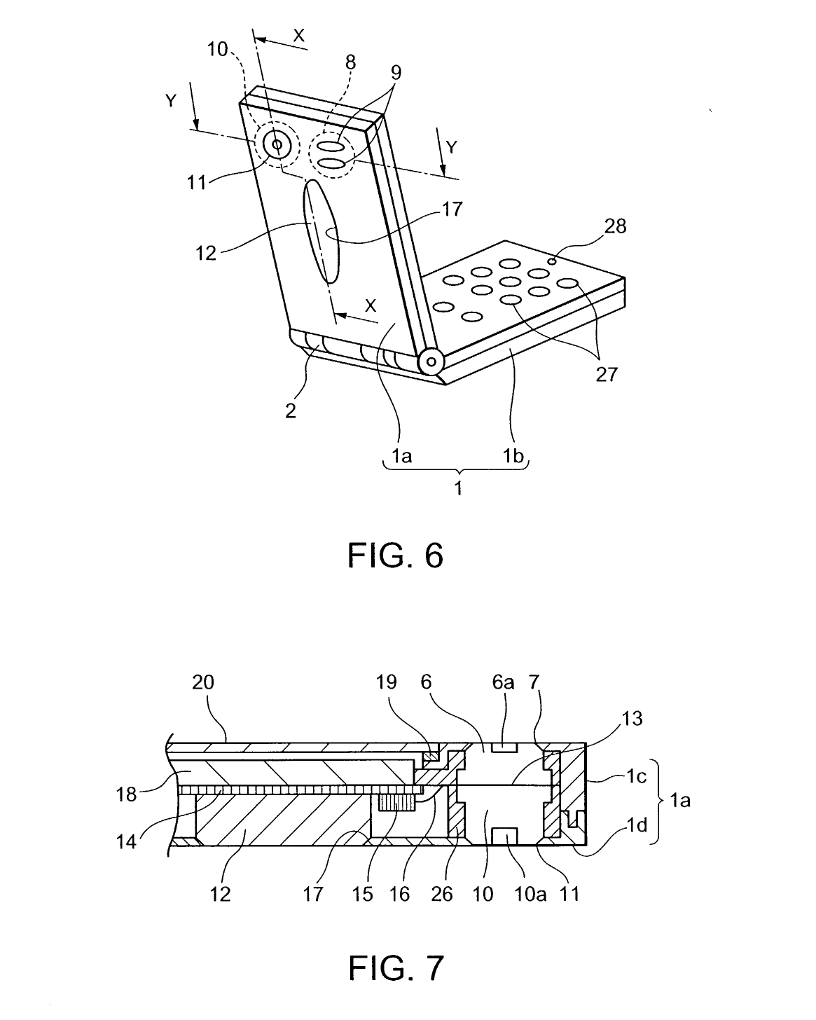

As shown in FIG. 6 (rear perspective view), on the upper end portion of the upper casing 1a, a speaker 8 for generating a variety of call arrival melodies is provided, as well as a sound passage hole 9 for passing through sounds from the speaker 8. Further, adjacent to the speaker 8, a long-range camera module 10 that has a greater magnifying power than the close-range-photography camera module 6 is provided. The long-range camera module 10 is appropriate for long-range photography, since it has a focus distance of from 1 m to infinity. An open lens window 11 is provided so that a lens portion of the camera module 10 is exposed. Further, at a central portion of the rear surface of the upper casing 1a, there is provided a flash 12 having a strong illumination function so as to allow photography in a dark place.

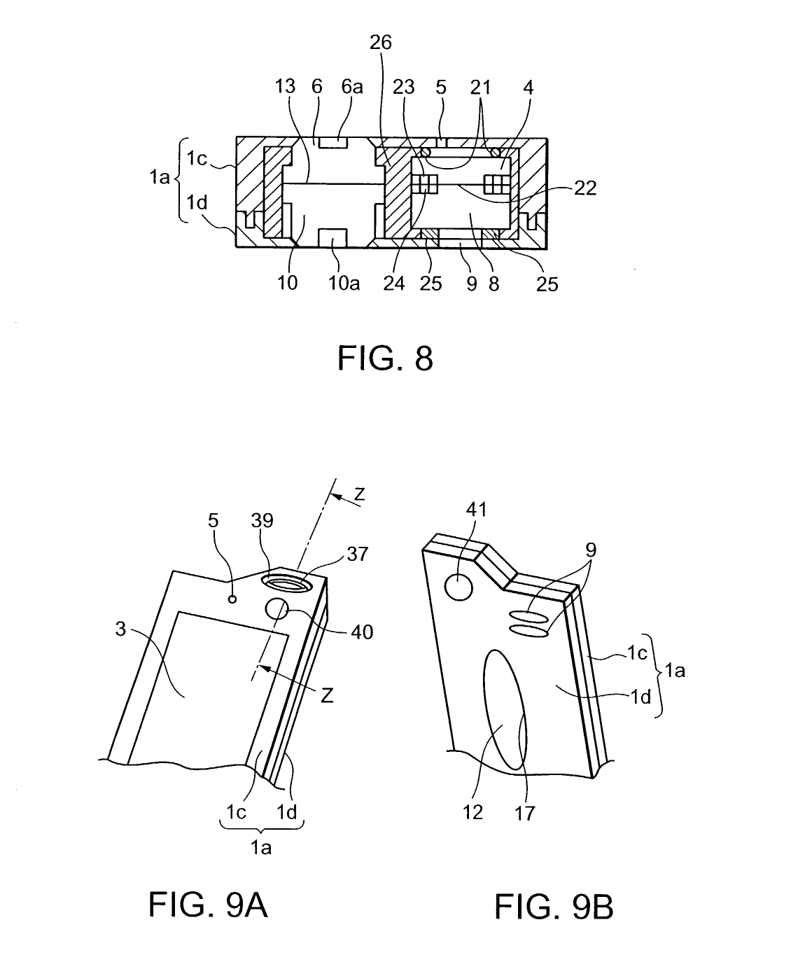

FIG. 7 (cross-section along line X-X in FIG. 6) and FIG. 8 (cross-section along line Y-Y in FIG. 6) illustrate the internal packaging structure of the upper casing 1a. In FIG. 7, the close-range camera module 6 is mounted onto a camera module printed circuit board 13 and fixed inside the upper casing 1a onto a front surface thereof. A lens 6a is exposed through the lens window 7 provided in a front cover 1c of the upper casing 1a. Further, the close-range camera module 6 is connected to a connector 15 mounted on a main printed circuit board 14 inside the upper casing 1a, via a flexible printed circuit board 16.

The long-range camera module 10 is mounted onto the camera module printed circuit board 13 on the opposite side from the close-range camera module 6 and fixed inside the upper casing 1a on the back side thereof. The lens 10a is exposed through the lens window 11 provided on a back cover 1d of the upper casing 1a. The long-range camera module 10 is also connected via the to the connector 15 via the flexible printed circuit board 16.

The flash 12 is exposed through a flash window 17 provided in the back cover 1d. A LCD module 18 is also mounted to the main printed circuit board 14, and the front surface thereof is protected by means of a transparent resin plate adhered/fixed to the front cover 1c with double-sided tape 19.

In FIG. 8, the receiver 4 is mounted to a flexible printed circuit board 22 extended from the LCD module 18 and fixed inside the upper casing 1a to the front surface thereof. Between the receiver 4 and the inner surface of the front cover 1c, there are provided cushions 21, each formed in a ring shape and made of a soft material, e.g., foam urethane or similar materials. The cushions 21 prevent the leakage of the sound that has been generated, while emitting the sound to the exterior through the sound passage hole 5. This receiver 4 is electrically connected to a connection land of the flexible printed circuit board 22 by means of a metallic flat spring 23. Note that conductive rubber may be used instead of the flat spring 23.

Further, the speaker 8 is fixed to the flexible printed circuit board 22 on the opposite side from the receiver 4, and is fixed inside the upper casing 1a to the back side thereof. Similarly, it is electrically connected to the connection land of the flexible printed circuit board 22 by means of a metallic flat spring 24. This flat spring 24 may also be replaced with the conductive rubber. Between the speaker 8 and the inner surface of the back cover 1d, there are provided cushions 25, each formed in a ring shape and made of a soft material, e.g., as foam urethane or similar material. The cushions 25 prevent the leakage of the sound that has been generated, while emitting the sound to the exterior through the sound passage hole 9.

A frame 26 positions and holds together the close-range camera module 6, the flexible printed circuit board 16, the long-range camera module 10, the receiver 4, the speaker 8 and the flexible printed circuit board 22 within the upper casing 1a. The frame 26 determines the position of and holds the LCD module 18 on the main printed circuit board 14.

The lower casing 1b comprises a front cover 1e and a back cover 1f, and on the front cover 1e there is provided an operation portion 27 allowing operations of the respective functions of the mobile phone, and a microphone hole 28 enabling input of the user's voice. Further, a power source is built in the lower casing 16.

Thus, the respective components comprising the camera module, the speaker and the receiver, which would otherwise increase the thickness of the device, can be concentrated at the upper edge of the upper casing 1a. These components do not overlap the LCD module 18, and therefore the upper casing 1a can be made thinner.

When the user selects the close-range-photography camera module 6 on the front side, the user can face the camera and conduct a video telephone call, or can extend his arm while holding the mobile phone to photograph several people including himself. When the user selects the long-range camera module 10 on the rear side, he can photograph a slightly distant subject or scenery or the like. If the photography environment is dark, the flash 12 can be used to supplement the photography conditions to obtain necessary exposure.

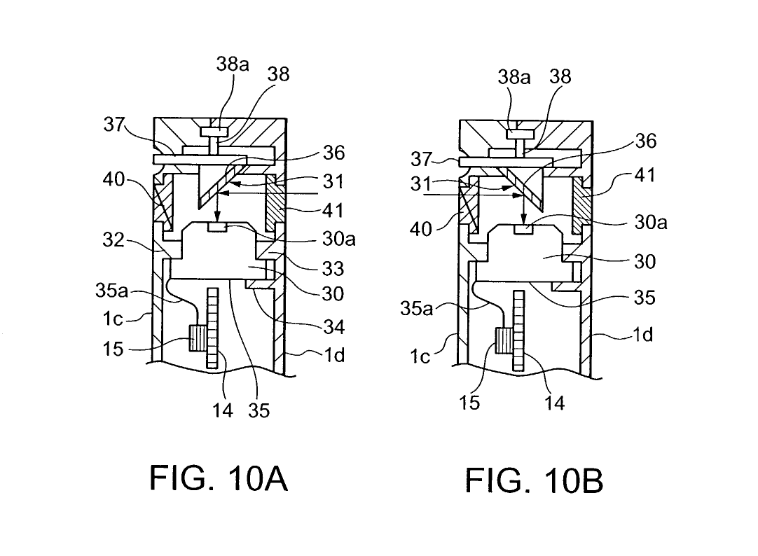

Next, a second embodiment of the present invention will be described. FIG. 9A is a front side perspective view of a part of the upper casing 1a, and FIG. 9B is a rear side perspective view of the same. FIG. 10A and FIG. 10B are cross-sectional views along a line Z-Z shown in FIG. 9A.

In the second embodiment, a single camera module is used, instead of two camera modules (see the above description). As shown in FIGS. 9A and 10A, a camera module 30 is fixed inside the upper casing 1a so as to face upward. An optical-path-switching optical system 31, which is mounted at an upper edge portion inside the upper casing 1a, switches an optical path. This allows the user to switch between a subject on the front side of the upper casing 1a and a second subject on the rear side of the upper casing 1a when photographing.

Referring to FIG. 10A, the camera module 30 is pinched by a rib 32 extending from the front cover 1c of the upper casing 1a and by a rib 33 extending from the back cover 1d. The camera module 30 is supported from below by a rib 34 extending from the back cover 1d, whereby the lens 30a is fixed inside the upper casing 1a while facing upward. The camera module 30 itself is mounted on a flexible printed circuit board 35, and is electrically connected to the connector 15 on the main printed circuit board 14 by means of an extending portion 35a of the flexible printed circuit board 35.

The optical-path-switching optical system 31 has a mirror unit 36 sloped at approximately 45 degrees and fixed to a bottom surface of a thin disc-shaped knob 37. A rotating shaft 38 protruding out from the upper surface of this knob 37 is held in a freely rotatable fashion by means of a flange portion 38a on the upper end, and by the front cover 1c and the back cover 1d of the upper casing 1a. Therefore, the mirror surface of the mirror unit 36 and the lens section 30a of the camera module 30 vertically oppose each other. A part of the knob 37 extends out from a slit 39 in the front cover 1c. By applying a finger to the extended portion and rotating/manipulating it, the mirror unit 36 can be rotated in 180 degrees or 360 degrees as shown by the arrow in FIG. 9A.

The front cover 1c and the back cover 1d are provided with a front-side photography window 40 and a rear-side photography window 41 made of transparent resin, respectively located at positions opposing the mirror unit 36 in a lateral direction.

As shown in FIG. 10A, when the mirror unit 36 is facing the rear-side photography window 41, the light rays from the subject on the rear side of the upper casing 1a pass through the transparent rear-side photography window 41 and enter inside the upper casing 1a. The mirror unit 36 reflects the light rays and they enter the lens section 30a of the camera module 30.

As shown in FIG. 10B, when the mirror unit 36 faces the front-side photography window 40, the light rays from the subject on the front side of the upper casing 1a pass through the transparent front-side photography window 40 and enter inside the upper casing. The mirror unit 36 reflects the light rays and they enter the lens portion 30a.

Regardless of whether the subject to be photographed is on the front side or on the rear side of the upper casing 1a, the appropriate image can be obtained simply by rotating the mirror unit 36 by manipulating the knob 37. This avoids the use of complicated connecting wiring, which is required when the camera module itself is rotated. Note that the photographing angle of the image reflected by the mirror unit 36 is corrected by means of an internal control circuit.

A prism may be used to replace the mirror unit 36. In an alternative embodiment, the front-side photography window 40 could be a transparent resin and the rear-side photography window 41 could be a lens. This allows the orientation of the mirror unit 36 to be inverted to switch between close-range photography and long-range photography using the one camera module 30. Alternatively, both the front-side photography window 40 and the rear-side photography window 41 can be lenses with different focus points.

Obviously, numerous additional modifications and variations of the present invention are possible in light of the above teachings. It is, therefore, to be understood that within the scope of the appended claims, the invention may be practiced otherwise than as specifically described herein.

What is claimed is:

1. A portable communications terminal, comprising:
a first casing;
a second casing connected to said first casing;
a first taking means for capturing image disposed on said first casing; and
a second taking means for capturing image disposed on said second casing;
receiving means for receiving a wireless signal; and
display means for displaying information.

2. The portable communications terminal as claimed in claim 1, wherein the optical characteristics of said first taking means and said second taking means differ from each other.

3. The portable communications terminal as claimed in claim 2, wherein said first taking means is for close-range photography and said second taking means is for long-range photography.

4. The portable communications terminal as claimed in claim 3, wherein said first taking means and said second taking means are arranged in a manner such that they are positioned back-to-back to each other.

5. The portable communications terminal as claimed in claim 4, further comprising an illuminating means.

6. The portable communications terminal as claimed in claim 5, wherein said illuminating means is disposed on at least one of said first casing and said second casing.

7. The portable communications terminal as claimed in claim 6, wherein said portable communications terminal is a portable telephone.

8. The portable communications terminal as claimed in claim 1, further comprising outputting means for outputting sound.

9. A portable communications terminal, comprising:
a first casing;
a second casing connected to said first casing;
a taking means for capturing images;
a first photography window disposed in said first casing;
a second photography window disposed in said second casing;
a switching means for switching between an image from said first photography window and an image from said second photography window; and
a directing means for directing said image to said taking means receiving means for receiving a wireless signal; and
display means for displaying information.

10. The portable communications terminal as claimed in claim 9, wherein said switching means is manually switched.

11. The portable communications terminal as claimed in claim 10, further comprising a lens arranged in at least one of said first photography window and said second photography window.

12. The portable communications terminal as claimed in claim 11, further comprising an illuminating means.

13. The portable communications terminal as claimed in claim 12, wherein said illuminating means is disposed on at least one of said first casing and said second casing.

14. The portable communications terminal as claimed in claim 13, wherein said portable communications terminal is a portable telephone.

15. The portable communications terminal, as claimed in claim 9, further comprising an outputting means for outputting sound.

16. A portable communications terminal, comprising:
a first casing;
a second casing connected to said first casing;
a first camera module disposed on said first casing; and
a second camera module disposed on said second casing;
a receiver that receives a wireless signal; and
a display that displays information.

17. The portable communications terminal as claimed in claim 16, wherein the optical characteristics of said first camera module and said second camera module differ from each other.

18. The portable communications terminal as claimed in claim 17, wherein said first camera module is for close-range photography and said second camera module is for long-range photography.

19. The portable communications terminal as claimed in claim 18, wherein said first camera module and said second camera module are arranged in a manner such that they are positioned back-to-back with each other.

20. The portable communications terminal as claimed in claim 19, further comprising a flash unit.

21. The portable communications terminal as claimed in claim 20, wherein said flash using is disposed on at least one of said first casing and said second casing.

22. The portable communications terminal as claimed in claim 21, wherein said portable communications terminal is a portable telephone.

23. The portable communications terminal as claimed in claim 16, further comprising an outputting circuit that outputs sound.

24. A portable communications terminal, comprising:
a first casing;
a second casing for connecting with said first casing;
a camera module;
a first photography window disposed in said first casing;
a second photography window disposed in said second casing; and
a switching circuit that switches between an image from said first photography window and an image from said second photography window;
a directing circuit for directing said image to said camera module;
a receiver that receives a wireless signal; and
a display that displays information.

25. The portable communications terminal as claimed in claim 24, wherein said switching circuit is manually switched.

26. The portable communications terminal as claimed in claim 25, further comprising a lens arranged for at least one of said first photography window and said second photography window.

27. The portable communications terminal as claimed in claim 26, further comprising a flash unit.

28. The portable communications terminal as claimed in claim 27, wherein said flash unit is disposed on at least one of said first casing and said second casing.

29. The portable communications terminal as claimed in claim 28, wherein said portable communications terminal is a portable telephone.

30. The portable communications terminal as claimed in claim 24, further comprising an outputting circuit that outputs sound.

31. A portable communications terminal comprising:
a first camera module oriented toward a front side of said portable communications module; and
a second camera module oriented toward a rear side of said portable communications module.

32. The portable communications terminal as claimed in claim 31, wherein the optical characteristics of said first camera module and said second camera module differ from each other.

33. The portable communications terminal as claimed in claim 32, wherein one of said first camera module and said second camera module is for close-range photography and the other is for long-range photography.

34. The portable communications terminal as claimed in claim 33, wherein said first camera module and said second camera module are arranged such that they are positioned back-to-back with each other.

35. A portable communications terminal comprising:
a camera module;
photography windows disposed in a front surface and in a rear surface of said portable communications terminal, respectively; and
an optical-path-switching optical system disposed inside said portable communications terminal for switching between an image from the front-side photography window and an image from the rear-side photography window and directing the image to said camera module.

36. The portable communications terminal as claimed in claim 35, wherein said optical-path-switching optical system is a mirror unit.

37. The portable communications terminal as claimed in claim 36, further comprising a lens arranged to at least one of said front-side photography window and said rear-side photography window.

38. The portable communications terminal as claimed in claim 37, further comprising a flash unit.

39. The portable communications terminal as claimed in claim 36, wherein said front-side photography window is a transparent resin and said rear-side photography window is a lens.

40. The portable communications terminal as claimed in claim 36, wherein said front-side photography window is a first lens and said rear-side photography window is a second lens, said first and second lens having different focal lengths.

41. The portable communications terminal as claimed in claim 35, herein said optical-path-switching optical system is a prism.
